(19) United States
(12) Patent Application Publication
(10) Pub. No.: US 2011/0085423 A1
(43) Pub. Date: Apr. 14, 2011

(54) Alarm Clock with Bedpost Pressure Sensor

(75) Inventor: Brian Cottrell, Redondo Beach, CA (US)

(73) Assignee: Brian Cottrell, Redondo Beach, CA (US)

(21) Appl. No.: 12/694,987

(22) Filed: Jan. 27, 2010

Related U.S. Application Data
(60) Provisional application No. 61/250,656, filed on Oct. 12, 2009.

(51) Int. Cl. G04C 21/16

(52) U.S. Cl. 368/250; 368/262

(57) ABSTRACT

An alarm clock with bedpost pressure sensor including an alarm clock in data communication with a pressure sensor that can be placed under a bedpost. The pressure sensor determines whether or not a bed is occupied based on the weight of the bed and its contents. If the pressure sensor detects that a bed is occupied then an alarm may sound, and if detects that the bed is unoccupied then the alarm is terminated.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of alarm clocks. More particularly, the present invention is in the technical field of alarm clocks in communication with a pressure sensor. Alarm clocks are widely used as a means of waking a sleeping individual at a desired time of day. Traditionally an alarm clock sounds an alarm at a time that the user has preset the alarm to activate. Typically, the alarm continues to sound until it is deactivated by the user. If it is not deactivated then it sounds for some predetermined amount of time.

Typically an alarm sounds regardless of whether or not the alarm clocks user is nearby. If the user is not nearby at the time that the alarm sounds, it will continue to sound until the earlier mentioned predetermined amount of time has passed. This prolonged alarm may have undesirable consequences for any person that is close enough to the alarm clock to hear the alarm but who is unable to or does not wish to access the alarm clock to deactivate it.

Therefore, it would be desirable to have an alarm clock that includes a means of detecting whether or not a user is in bed so that it does not sound when the user is not in bed. Further, it would be desirable to have an alarm clock that immediately deactivates when the user leaves the bed. In addition it would be desirable to have an alarm clock that includes all of the functionality of a traditional alarm clock as well a pressure sensor to determine whether or not the user is in bed and user controls relative to the sensor.

In the prior art, alarm clock devices are well known and include an extensive array of structural and functional variations built to fulfill countless objectives and specifications. Know alarm clock devices include U.S. Pat. Nos. 2,999,928; 4,218,875 and 4,234,944. The digital alarm clock of the present invention is preferably based on the digital clock disclosed in U.S. Pat. No. 5,487,053. U.S. Pat. No. 4,316,273 discloses an alarm clock in communication with a remote deactivation switch. While above mentioned devices fulfill their particular objectives, they do not include a bedpost pressure sensor in communication with an alarm clock.

The use of a pressure controlled alarm system is disclosed in U.S. Pat. No. 5,764,153, which describes an alarm clock in communication with a mechanical pressure switch placed between the mattress and box spring of a bed. While the invention disclosed in U.S. Pat. No. 5,764,153 and the present invention perform similar objectives; the present invention eliminates the difficulties of accessing and calibrating a mechanical switch that is located between a mattress and box spring by placing a load cell under a bedpost. The pressure sensor is further improved in the present invention by using accurate digital calibration means as well as wireless capabilities.

### BRIEF SUMMARY OF THE INVENTION

The present invention is an alarm clock with a bedpost pressure sensor. The invention includes an alarm clock with all of the functionality of a typical alarm clock. The alarm clock is in data communication with a pressure sensor that can be placed under a bedpost. The pressure sensor is used to determine whether or not a bed is occupied based on the weight of the bed. If the pressure sensor detects that a bed is unoccupied, then an alarm does not sound.

Therefore a general object of this invention is to provide a pressure sensor that can be placed under a bedpost and reliably detect whether or not the bed is occupied regardless of the size and shape of the bed.

Another object of this invention is to provide an alarm clock in data communication with the above mentioned pressure sensor so that the alarm of the alarm clock may be deactivated when the pressure sensor detects that a bed is not occupied.

Still another object of the invention is to provide an alarm clock with a pressure sensor that includes all of the functionality of a traditional alarm clock as well as user controls specific to the pressure sensor.

### BRIEF DESCRIPTION OF THE SEVERAL VIEWS OF THE DRAWING

FIG. 1 is a perspective view of an alarm clock with bedpost pressure sensor in accordance with certain preferred embodiments of the present invention;

FIG. 2 is a front view of the alarm clock with bedpost pressure sensor of FIG. 1;

FIG. 3 is a back view of the alarm clock with bedpost pressure sensor of FIG. 1; and

FIG. 4 is a block diagram of electronic circuitry of the alarm the alarm clock with bedpost pressure sensor of FIG. 1 in accordance with certain preferred embodiments of the present invention.

### DETAILED DESCRIPTION OF THE INVENTION

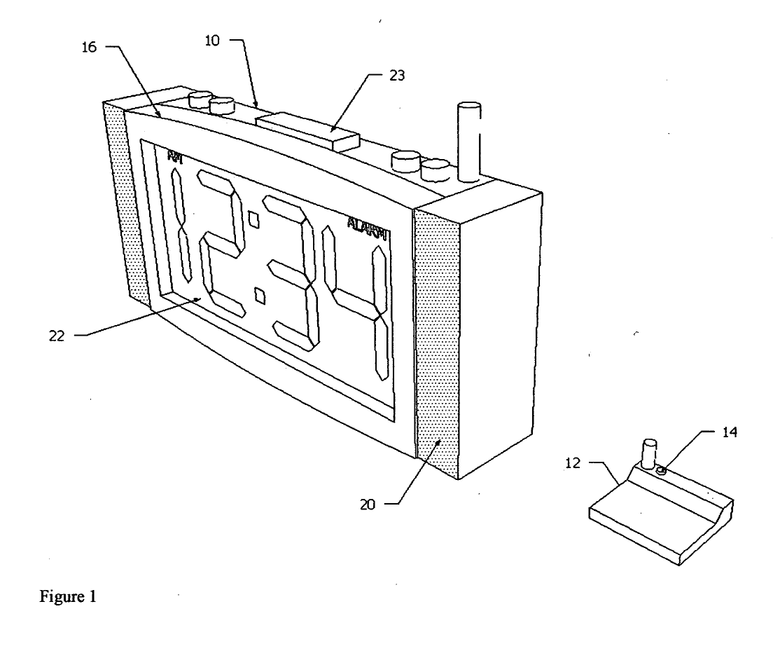

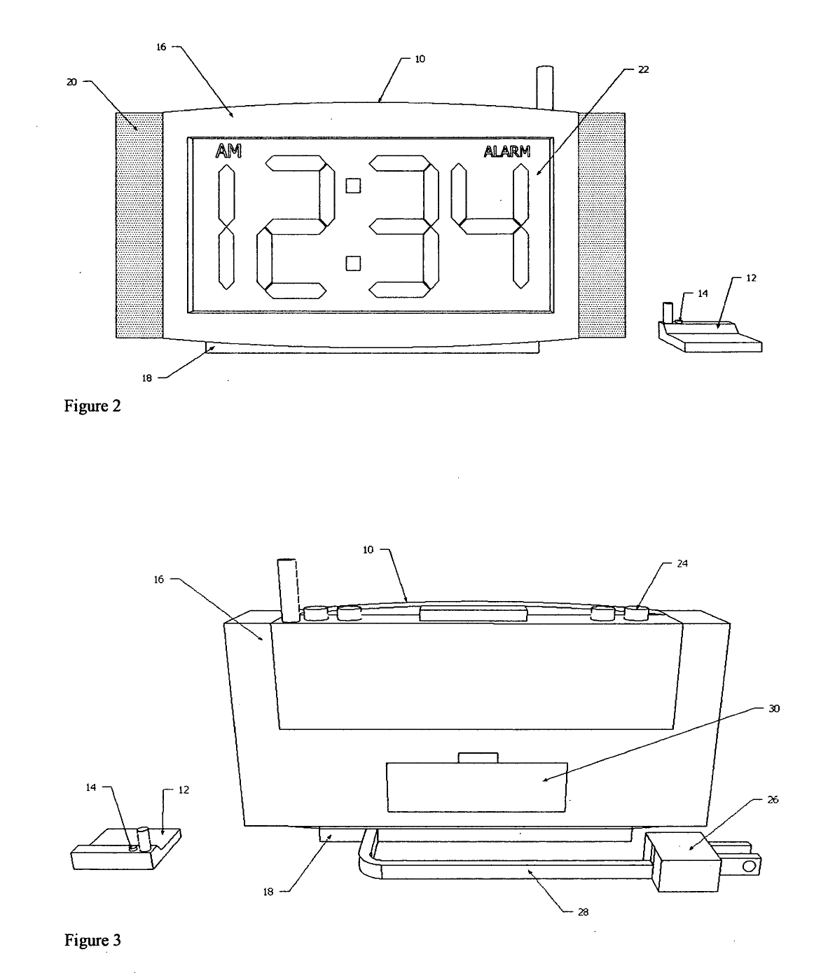

Referring now to the invention in more detail, in FIG. 1 to FIG. 3 there is shown an alarm clock with bedpost pressure sensor including a base unit 10 and a pressure sensor 12 spaced from the base unit 10. In the preferred embodiment, the pressure sensor 12 includes a set button 14 used to calibrate the sensor. The base unit 10 preferably includes a housing 16 with a stand 18, at least one speaker 20, a visual display 22, and a set of buttons and/or knobs 24 for controlling the operation of the alarm clock with bedpost pressure sensor. The base unit 10 also may includes an electrical plug 26 and electrical wire 28 extending between the electrical plug 26 and base unit 10 for supplying power to the base unit 10. The base unit 10 may also include a battery compartment 30 in place of or in addition to the electrical plug 26.

In more detail, still referring to the invention of FIG. 1 to FIG. 3 the base unit 10 performs the functions of an alarm clock. The base unit 10 preferably includes a set of buttons and/or knobs 24 for setting the current time of day and the time of day at which the alarm will sound. In the preferred embodiment, the pressure sensor 12 is placed under a bedpost. While the bed is unoccupied, the set button 14 is pressed. In the preferred embodiment, when the set button 14 is pressed the speaker 20 is disabled. The speaker 20 is enabled only while the pressure sensor 12 detects a sufficient increase in pressure.

In further detail, still referring to the invention of FIG. 1 to FIG. 3, the base unit 10 is sufficiently small to be conveniently placed in a bedroom. Preferably, the pressure sensor 12 is sufficiently thin to be placed under a bedpost without significantly affecting the height of the bed.

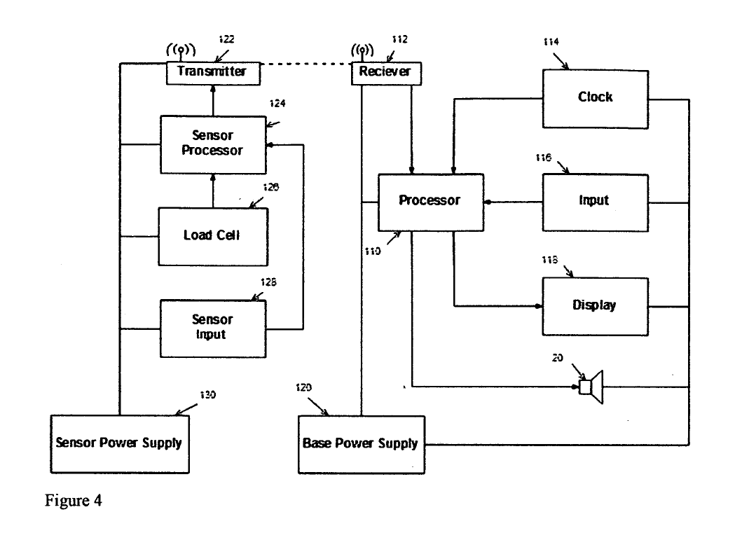

Referring now to the invention shown in FIG. 4 there is shown a block diagram of the electronic circuitry of an alarm clock with bedpost pressure sensor in accordance with certain preferred embodiments of the present invention. The base unit 10 includes a processor 110 that is in data communication with a receiver 112, a clock 114, a user input 116, a display 118, and at least one speaker 20. The user input 116 includes the set of buttons and or knobs 24 as shown in FIG. 1. The display 118 is preferably and LED or LCD display. A base power supply 120 electrically powers the processor 110, the receiver 112, the clock 114, the user input 116, the display 118, and the speaker 20.

The pressure sensor 12 includes a transmitter 122, a sensor processor 124, a load cell 126, and a sensor input 128 that are all electrically powered by a sensor power supply 130. In the preferred embodiment, the sensor input includes a set button 14.

In more detail, still referring to the invention in FIG. 4, in the preferred embodiment, the load cell 126 of the pressure sensor 12 is placed under a bedpost. The load cell 126 provides an analog voltage signal that is dependent on the amount of pressure applied across its surface. The analog signal is read by an analog to digital converter on the sensor processor 124 to assign a digital pressure value to the amount of pressure on the load cell 126. While the bed is unoccupied, the set button 14 is pressed. While the set button 14 is depressed, the current pressure value is stored within the processor. When the set button 14 is released, the pressure value is continuously compared to the stored pressure value. Whenever the sensor processor 124 reads a sufficient increase in pressure, the sensor processor 124 indicates that the bed is occupied. The occupation status of the bed is transmitted wirelessly from the transmitter 122 of the pressure sensor 12 to the receiver 112 of the base unit. The wireless transmitter 122 and receiver 112 preferably operate in the radio frequency range however, other frequencies may be used. The wireless signal preferably has a range of at least 5 meters.

In the preferred embodiment, the base unit 10 includes all the functionality of a traditional alarm clock. A processor 110 is in data communication with a clock 114 and a display 118. The processor 110 takes input from the clock 114 to accurately show the time of day on the display 118. The processor 110 is also in data communication with a user input 116 that includes functions that allow the user to set the current time, the time at which the alarm will activate, and the on/off status of the alarm. The processor is additionally in data communication with the receiver 122, which receives a signal sent by the transmitter 122 of the pressure sensor 12. The received signal indicates the occupation status of the bed. If the alarm is turned on, it will sound at the time of day set by the user unless the signal sent by the receiver 122 indicates that the bed is unoccupied in which case it will not sound or stop sounding.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. An alarm clock with bedpost pressure sensor comprising:
an alarm clock unit programmable to produce an audible alarm signal at a preset time;
a pressure sensing means in data communication with said alarm clock unit;
wherein said pressure sensing means comprises:
a load cell located beneath a bedpost of a bed;
a load cell circuit capable of producing an electrical signal to indicate the amount of pressure across said load cell caused by the weight of said bed and its contents;
a means of transferring data from said pressure sensing means to said alarm clock unit;
and said alarm clock unit comprises:
a means of receiving data from said pressure sensing means;
a means of producing an electrical status signal based on data received from said pressure sensing means to indicate whether said bed is occupied or unoccupied;
a means of disabling said audible alarm signal if said bed is unoccupied.

2. The alarm clock with bedpost pressure sensor of claim 1 wherein said pressure sensing means includes a flat load cell unit containing said load cell wherein said load cell unit can be place under a bedpost of a bed so that the weight of said bed applies a pressure across said load cell.

3. The alarm clock with bedpost pressure sensor of claim 1 wherein said pressure sensing means is built directly into a bedpost of a bed so that the weight of said bed applies a pressure across said load cell.

4. The alarm clock with bedpost pressure sensor of claim 1 wherein said means of transferring data from said pressure sensing means to said alarm clock unit comprises; a wireless transmitter located on said pressure sensing means capable of transmitting a data signal to a wireless receiver on said alarm clock unit.

5. The alarm clock with bedpost pressure sensor of claim 1 wherein said load cell circuit comprises:
a power source;
a voltage divider electrically coupled to said power source and said load cell to produce a voltage signal proportional to the resistance of said load cell;
a transmitter circuit coupled to said voltage signal and said means of transferring data from said pressure sensing means to said alarm clock unit.

6. The alarm clock with bedpost pressure sensor of claim 5 wherein said transmitter circuit includes a microcontroller coupled to said voltage signal and a set button wherein said microcontroller contains programming to read and store said voltage signal when said set button is pressed, read and compare said voltage signal to said stored voltage signal when said set button is released, and calculate the occupation status of said bed using said voltage signals.

7. The alarm clock with bedpost pressure sensor of claim 5 wherein said transmitter circuit transfers said voltage signal to said alarm clock unit wherein said alarm clock unit includes a set button and means of reading and storing said voltage signal when said set button is pressed, comparing said voltage signal to said stored voltage signal when said set button is released, and calculating the occupation status of said bed using said voltage signals.

8. The alarm clock with bedpost pressure sensor of claim 5 wherein said voltage signal is read by a microcontroller programmed to automatically calculate the occupation status of said bed using various changes in said voltage signal associated with a person entering and leaving said bed.

9. The alarm clock with bedpost pressure sensor of claim 5 wherein a signal indicating the occupation status of said bed is transferred to multiple alarm clock units wherein said alarm clock units contain control circuits with programming to enable one or more alarm clock units to produce an audible alarm signal and disable all others if said bed is occupied.
